(19) United States
(12) Patent Application Publication
(10) Pub. No.: US 2016/0103612 A1
(43) Pub. Date: Apr. 14, 2016

(54) Approximation of Execution Events Using Memory Hierarchy Monitoring

(71) Applicant: QUALCOMM Incorporated, San Diego, CA (US)

(72) Inventors: Mihai Christodorescu, San Jose, CA (US); Mastooreh Salajegheh, San Jose, CA (US); Dario Suarez Gracia, Santa Clara, CA (US)

(21) Appl. No.: 14/512,434

(22) Filed: Oct. 12, 2014

(51) Int. Cl. G06F 3/06; G06F 21/56

(52) U.S. Cl. CPC G06F 3/0604; G06F 21/56; G06F 3/0653; G06F 3/0673; G06F 2221/034

(57) ABSTRACT

Aspects include computing devices, systems, and methods for implementing monitoring communications between components and a memory hierarchy of a computing device. The computing device may determine at least one identifying factor for identifying execution of the processor-executable code. A communication between the components and the memory hierarchy of the computing device may be monitored for at least one communication factor of a same type as the at least one identifying factor. A determination whether a value of the at least one identifying factor matches a value of the at least one communication factor may be made. The computing device may determine that the processor-executable code is executed in response to determining that the value of the at least one identifying factor matches the value of the at least one communication factor.

### BACKGROUND

Monitoring execution events at the hardware layer and in real-time allows for monitoring of application programming interface (API) calls. Monitoring API calls is useful for malware detection, malfunction detection, protecting software with hardware, and tying monitoring to hardware. The API calls may be monitored for unusual instances and patterns that may indicate that a computing device is not operating as intended. One way to monitor execution events is by monitoring central processor unit (CPU) instruction streams. The instructions executed by the CPU may occur in instances and patterns that are identified as problematic for the computing device. However, monitoring all CPU instructions to find an execution of a specific address is both complicated and inefficient. Moreover, not all computing device systems support CPU monitoring. To monitor the CPU instructions at the high frequency at which CPUs execute instructions requires additional high speed hardware added to the CPU and capable of monitoring the execution in the CPU at the same frequency.

### SUMMARY

The methods and apparatuses of various aspects provide circuits and methods for monitoring communications between components and a memory hierarchy of a computing device that may include determining an identifying factor for identifying execution of a processor-executable code, monitoring a communication factor in a communication between the components and the memory hierarchy of the computing device of a same type as the identifying factor, determining whether a value of the identifying factor matches a value of the communication factor, and determining that the processor-executable code is executed in response to determining that the value of the identifying factor matches the value of the communication factor. In an aspect, determining whether a value of the identifying factor matches a value of the communication factor may include determining whether a value of a first identifying factor matches a value of a first communication factor, determining whether a second identifying factor is needed to identify execution of the processor-executable code, and determining whether a value of the second identifying factor matches a value of a second communication factor in response to determining that the second identifying factor is needed to identify execution of the processor-executable code. In an aspect, a type of the identifying factor and the communication factor may include one of an entry point address of a target memory, an exit point address of a target memory, a callee function, a caller function, a parameter, a unique instruction, a unique pattern, a cache footprint, a local variable, and a return value.

An aspect method may further include determining whether communication matches another identifying factor is need to identify execution of the processor-executable code in response to determining that the value of the second identifying factor matches the value of the second communication factor. In an aspect, a type of the first identifying factor and the first communication factor is different from a type of the second identifying factor and the second communication factor. In an aspect, determining whether a second identifying factor is need to identify execution of the processor-executable code may include determining whether the second identifying factor is need to identify execution of the processor-executable code in response to in response to determining that the value of the first identifying factor matches the value of the first communication factor, the value of the first communication factor not uniquely identifying the processor-executable code, or an overhead for monitoring the first communication factor exceeds a threshold.

An aspect method may further include determining that the processor-executable code is not executed in response to determining that the value of the identifying factor does not match the value of the communication factor.

In an aspect, monitoring for a communication factor in a communication between the components and the memory hierarchy of the computing device of a same type as the identifying factor may include determining whether a memory access request to a first target memory of the memory hierarchy results in a miss, and monitoring a supplemental memory access request to a second target memory of a lower level of the memory hierarchy in response to determining that the memory access request results in a miss.

In an aspect, the communication may be associated with a target memory of the memory hierarchy, and the method further include determining whether the communication can be monitored and marking the communication un-cacheable in response to determining that the communication cannot be monitored.

### BRIEF DESCRIPTION OF THE DRAWINGS

The accompanying drawings, which are incorporated herein and constitute part of this specification, illustrate example aspects of the invention, and together with the general description given above and the detailed description given below, serve to explain the features of the invention.

FIG. 1 is a component block diagram illustrating a computing device suitable for implementing an aspect.

FIG. 2 is a component block diagram illustrating an example multi-core processor suitable for implementing an aspect.

FIG. 3 is a component block diagram illustrating an example system on chip (SoC) suitable for implementing an aspect.

FIG. 4 is an illustration of memory contents stored in various configurations relative to respective memory regions in a memory in accordance with an aspect.

FIG. 5 is an illustration of an interaction of memories in a memory hierarchy monitored by a stream monitor in accordance with an aspect.

FIG. 6 is process flow diagram illustrating an aspect method for implementing an approximation of execution events using memory hierarchy monitoring.

FIG. 7 is process flow diagram illustrating an aspect method for identifying memory contents of a monitored memory access request.

FIG. 8 is process flow diagram illustrating an aspect method for monitoring a memory access request resulting in a hit or a miss.

FIG. 9 is process flow diagram illustrating an aspect method for monitoring a memory access request targeting a memory that is not monitored.

FIG. 10 is component block diagram illustrating an example mobile computing device suitable for use with the various aspects.

FIG. 11 is component block diagram illustrating an example mobile computing device suitable for use with the various aspects.

FIG. 12 is component block diagram illustrating an example server suitable for use with the various aspects.

### DETAILED DESCRIPTION

The various aspects will be described in detail with reference to the accompanying drawings. Wherever possible, the same reference numbers will be used throughout the drawings to refer to the same or like parts. References made to particular examples and implementations are for illustrative purposes, and are not intended to limit the scope of the invention or the claims.

The terms “computing device” and “mobile computing device” are used interchangeably herein to refer to any one or all of cellular telephones, smartphones, personal or mobile multi-media players, personal data assistants (PDA's), laptop computers, tablet computers, smartbooks, ultrabooks, palm-top computers, wireless electronic mail receivers, multimedia Internet enabled cellular telephones, wireless gaming controllers, and similar personal electronic devices that include a memory, and a multi-core programmable processor. While the various aspects are particularly useful for mobile computing devices, such as smartphones, which have limited memory and battery resources, the aspects are generally useful in any electronic device that implements a plurality of memory devices and a limited power budget in which reducing the power consumption of the processors can extend the battery-operating time of the mobile computing device.

The term “system-on-chip” (SoC) is used herein to refer to a set of interconnected electronic circuits typically, but not exclusively, including a hardware core, a memory, and a communication interface. A hardware core may include a variety of different types of processors, such as a general purpose processor, a central processing unit (CPU), a digital signal processor (DSP), a graphics processing unit (GPU), an accelerated processing unit (APU), an auxiliary processor, a single-core processor, and a multi-core processor. A hardware core may further embody other hardware and hardware combinations, such as a field programmable gate array (FPGA), an application-specific integrated circuit (ASCI), other programmable logic device, discrete gate logic, transistor logic, performance monitoring hardware, watchdog hardware, and time references. Integrated circuits may be configured such that the components of the integrated circuit reside on a single piece of semiconductor material, such as silicon.

Aspects include methods and computing devices implementing such methods for execution event monitoring by monitoring instruction request lines to detect or recognize certain execution events. An aspect may use memory addresses as unique function identifiers in order to increase the probability of detecting execution events.

Code may be copied from a storage device or a processor to a main memory when an instruction execution function is called, and a loader may jump to the entry point of the function. The code may be copied to an instruction cache from the storage device or the processor either instead of the main memory or in addition to the main memory. The code may also be copied from the main memory to the instruction cache. No matter the manner in which the code is copied to the instruction cache, an association is created between execution events, such as calling the instruction execution function and cache entries. This association may be recognized at a bus level by observing instruction request lines, such as a miss instruction stream from the cache and non-cacheable accesses to the main memory. Thus, monitoring instruction request lines can provide information for monitoring of API calls triggered by specific execution events.

In an aspect, a stream monitor executing in hardware, software, or a combination of hardware and software may determine a memory address to monitor for an identified function. Based on the memory address, the stream monitor may monitor a memory region of the instruction cache and/or main memory. The memory region may be any portion of the instruction cache and/or main memory, for example a block of memory or a page of memory. The stream monitor may monitor all access requests to the memory region to identify access request containing the identified address as an entry point.

The memory address may point to a line in the instruction cache and/or main memory containing multiple functions. Monitoring access requests for the memory address may result in false identifications of an execution event if the function accessed at the memory address is a function other than the identified function. The memory address may be used in conjunction with other identifiers for the identified function to increase the probability of successfully detecting execution events. Examples of such other identifiers may include entry point, exit point, callee functions, caller functions, parameters (e.g. non-integers and buffers), unique instructions and patterns (e.g. loops), cache footprint, local variables, and return values.

With multiple cache levels, it may be difficult to monitor streams from each of the cache levels. Instructions stored at one of the difficult-to-monitor cache levels may not be monitored until the instructions are evicted from the cache. Thus, exit events may be lost for the access requests to these difficult to monitor cache levels. The stream monitor may mark access request as non-cacheable to force a cache miss and to direct the access request, and subsequent access request for the same memory address, to the main memory so that the access request may be monitored.

Being able to monitor access requests to the cache and/or main memory for specified memory address reduces the amount of monitoring that would otherwise have to be done to monitor CPU instructions because not all of the memory access requests must be monitored. Further, the frequency with which access requests to the specified memory address are made is likely slower than the processing frequency of the CPU. The memory addresses may be used in conjunction with other identifiers to identify access requests for certain functions where monitoring only the memory address may lead to false positives. Difficult to monitor access requests to certain levels of the cache may be altered to force the access request to the main memory in order to make the access request more visible to the stream monitor.

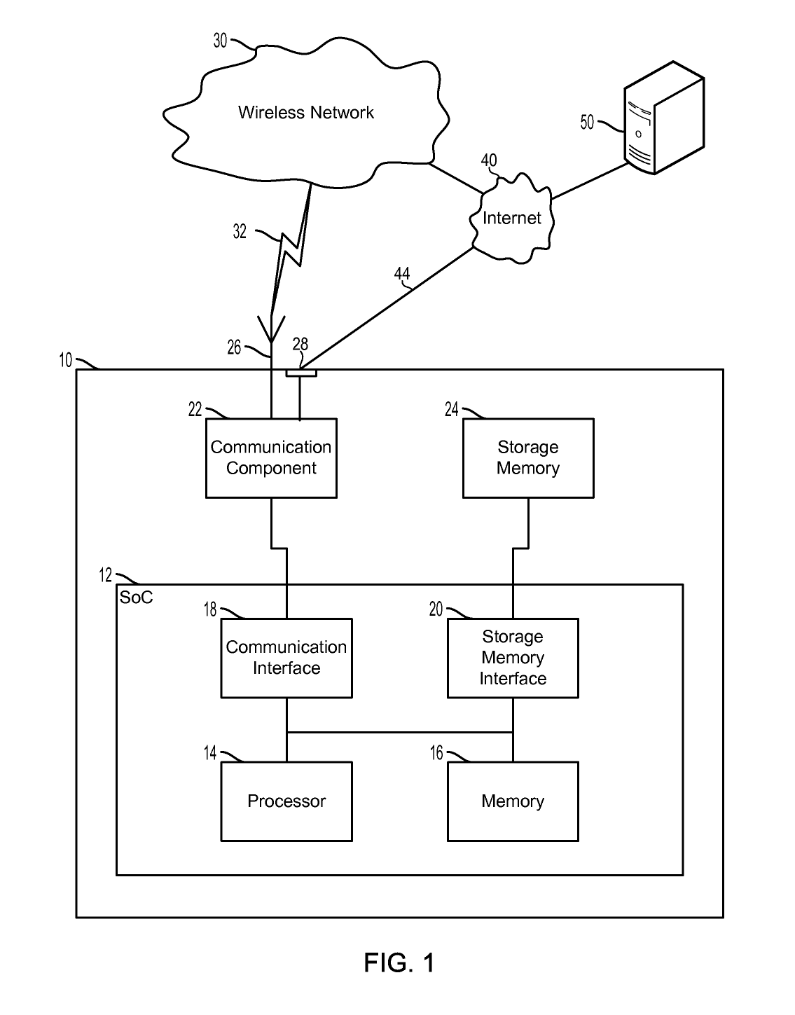

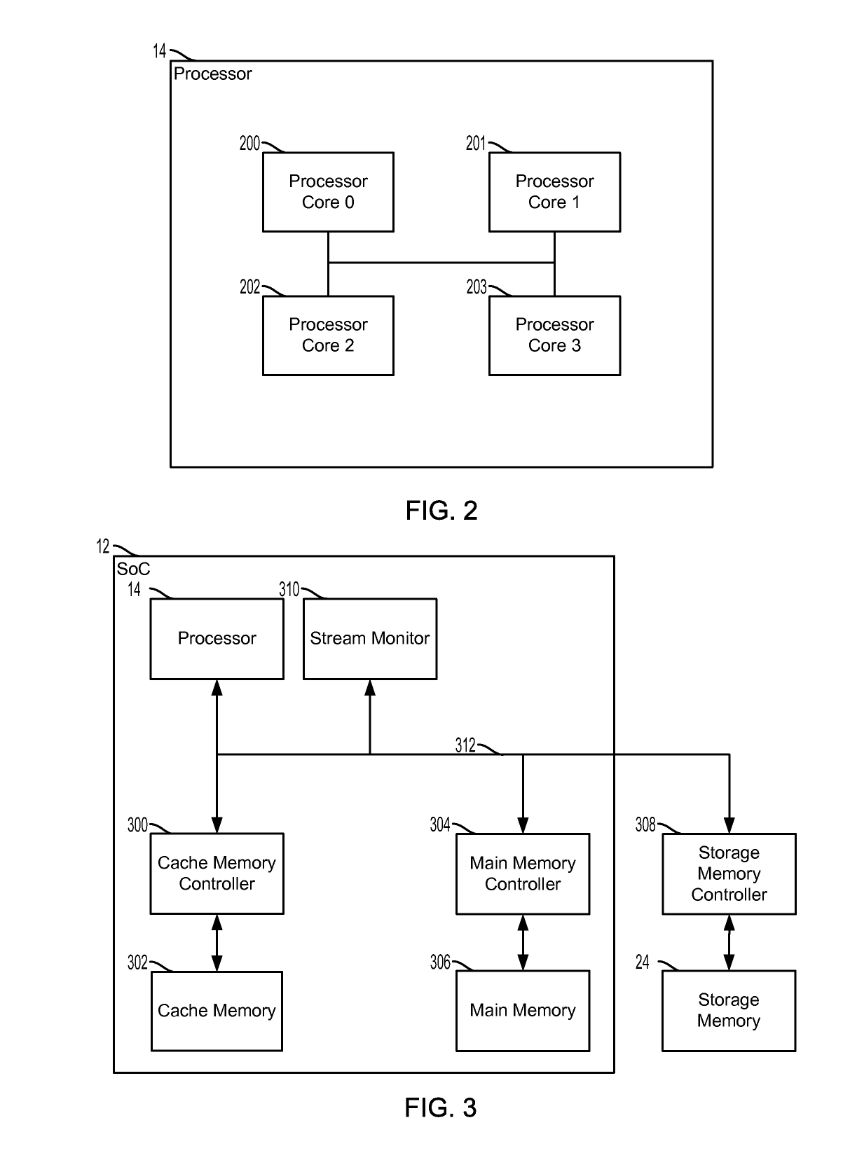

FIG. 1 illustrates a system including a computing device 10 in communication with a remote computing device 50 suitable for use with the various aspects. The computing device 10 may include an SoC 12 with a processor 14, a memory 16, a communication interface 18, and a storage memory interface 20. The computing device may further include a communication component 22 such as a wired or wireless modem, a storage memory 24, an antenna 26 for establishing a wireless connection 32 to a wireless network 30, and/or the network interface 28 for connecting to a wired connection 44 to the Internet 40. The processor 14 may include any of a variety of hardware cores, as well as a number of processor cores. The SoC 12 may include one or more processors 14. The computing device 10 may include more than one SoCs 12, thereby increasing the number of processors 14 and processor cores. The computing device 10 may also include processor 14 that are not associated with an SoC 12. Individual processors 14 may be multi-core processors as described below with reference to FIG. 2. The processors 14 may each be configured for specific purposes that may be the same as or different from other processors 14 of the computing device 10. One or more of the processors 14 and processor cores of the same or different configurations may be grouped together.

The memory 16 of the SoC 12 may be a volatile or non-volatile memory configured for storing data and processor-executable code for access by the processor 14. The computing device 10 and/or SoC 12 may include one or more memories 16 configured for various purposes. In an aspect, one or more memories 16 may include volatile memories such as random access memory (RAM) or main memory, or cache memory. These memories 16 may be configured to temporarily hold a limited amount of data and/or processor-executable code instructions that is requested from non-volatile memory, loaded to the memories 16 from non-volatile memory in anticipation of future access based on a variety of factors, and/or intermediary processing data and/or processor-executable code instructions produced by the processor 14 and temporarily stored for future quick access without being stored in non-volatile memory.

In an aspect, the memory 16 may be configured to store processor-executable code, at least temporarily, that is loaded to the memory 16 from another memory device, such as another memory 16 or storage memory 24, for access by one or more of the processors 14. In an aspect, the processor-executable code loaded to the memory 16 may be loaded in response to execution of a function by the processor 14. Loading the processor-executable code to the memory 16 in response to execution of a function may result from a memory access request to the memory 16 that is unsuccessful, or a miss, because the requested processor-executable code is not located in the memory 16. In response to a miss, a memory access request to another memory device may be made to load the requested processor-executable code from the other memory device to the memory device 16. In an aspect, loading the processor-executable code to the memory 16 in response to execution of a function may result from a memory access request to another memory device, and the processor-executable code may be loaded to the memory 16 for later access.

The communication interface 18, communication component 22, antenna 26, and/or network interface 28, may work in unison to enable the computing device 10 to communicate over a wireless network 30 via a wireless connection 32, and/or a wired network 44 with the remote computing device 50. The wireless network 30 may be implemented using a variety of wireless communication technologies, including, for example, radio frequency spectrum used for wireless communications, to provide the computing device 10 with a connection to the Internet 40 by which it may exchange data with the remote computing device 50.

The storage memory interface 20 and the storage memory 24 may work in unison to allow the computing device 10 to store data and processor-executable code on a non-volatile storage medium. The storage memory 24 may be configured much like an aspect of the memory 16 in which the storage memory 24 may store the processor-executable code for access by one or more of the processors 14. The storage memory 24, being non-volatile, may retain the information even after the power of the computing device 10 has been shut off. When the power is turned back on and the computing device 10 reboots, the information stored on the storage memory 24 may be available to the computing device 10. The storage memory interface 20 may control access to the storage memory 24 and allow the processor 14 to read data from and write data to the storage memory 24.

Some or all of the components of the computing device 10 may be differently arranged and/or combined while still serving the necessary functions. Moreover, the computing device 10 may not be limited to one of each of the components, and multiple instances of each component may be included in various configurations of the computing device 10.

FIG. 2 illustrates a multi-core processor 14 suitable for implementing an aspect. The multi-core processor 14 may have a plurality of homogeneous or heterogeneous processor cores 200, 201, 202, 203. The processor cores 200, 201, 202, 203 may be homogeneous in that, the processor cores 200, 201, 202, 203 of a single processor 14 may be configured for the same purpose and have the same or similar performance characteristics. For example, the processor 14 may be a general purpose processor, and the processor cores 200, 201, 202, 203 may be homogeneous general purpose processor cores. Alternatively, the processor 14 may be a graphics processing unit or a digital signal processor, and the processor cores 200, 201, 202, 203 may be homogeneous graphics processor cores or digital signal processor cores, respectively. For ease of reference, the terms “processor” and “processor core” may be used interchangeably herein.

The processor cores 200, 201, 202, 203 may be heterogeneous in that, the processor cores 200, 201, 202, 203 of a single processor 14 may be configured for different purposes and/or have different performance characteristics. Example of such heterogeneous processor cores may include what are known as “big.LITTLE” architectures in which slower, low-power processor cores may be coupled with more powerful and power-hungry processor cores.

In the example illustrated in FIG. 2, the multi-core processor 14 includes four processor cores 200, 201, 202, 203 (i.e., processor core 0, processor core 1, processor core 2, and processor core 3). For ease of explanation, the examples herein may refer to the four processor cores 200, 201, 202, 203 illustrated in FIG. 2. However, the four processor cores 200, 201, 202, 203 illustrated in FIG. 2 and described herein are merely provided as an example and in no way are meant to limit the various aspects to a four-core processor system. The computing device 10, the SoC 12, or the multi-core processor 14 may individually or in combination include fewer or more than the four processor cores 200, 201, 202, 203 illustrated and described herein.

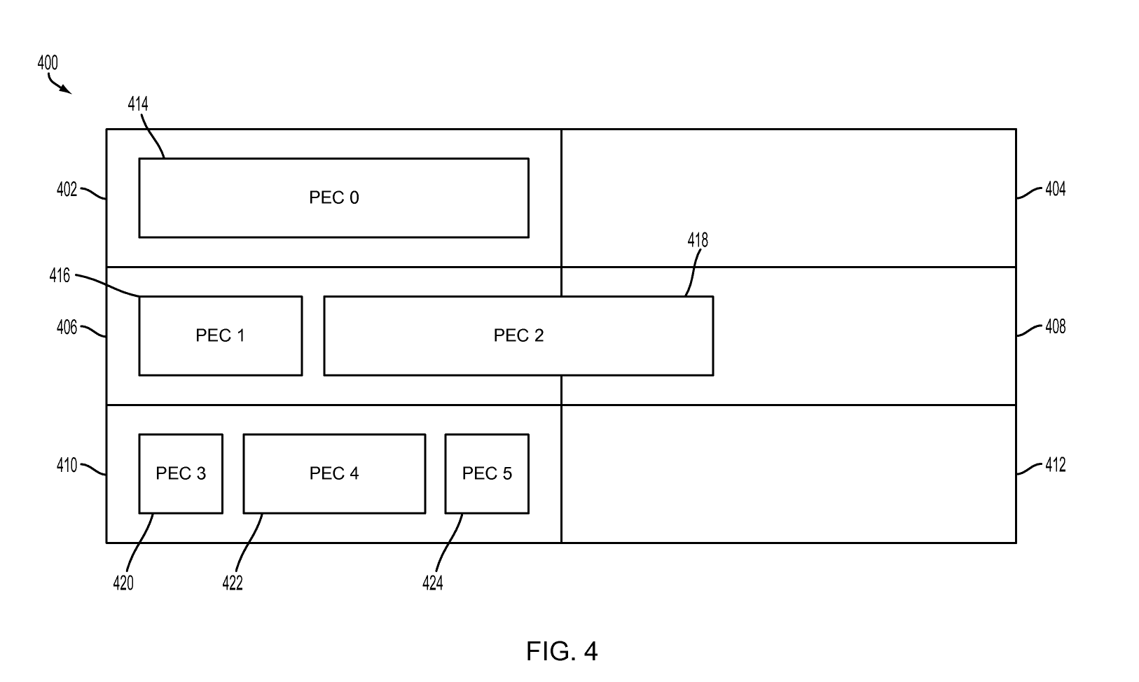

FIG. 3 illustrates an example SoC 12 including a cache memory controller 300, a cache memory 302, a main memory controller 304, a main memory 306, stream monitor 310, and other components such as the components of the SoC 12 described above. The SoC may also include or be communicatively connected to a storage memory controller 308 and the storage memory 24. Each of the cache memory 302, the main memory 306, and the storage memory 24 may be configured to store memory contents, such as data and/or processor-executable code. The memory contents may be stored a specific locations identified by physical addresses of the cache memory 302, the main memory 306, and the storage memory 24. In an aspect, memory access requests to the memories 24, 302, and 306 may be made using a virtual address that may be translated to the physical address of the respective memory 24, 302, and 306 in order to retrieve the requested memory contents of the memory access request. The storage locations of any of the data and/or processor-executable code may change with time. The physical addresses associated with the data and/or processor-executable code may be updated in a data structure mapping the locations of the data and/or processor-executable code for access by the processor 14.

The cache memory 302 may be configured to temporarily store data and/or processor-executable code for quicker access than is achievable accessing the main memory 306 or the storage memory 24. The cache memory 302 may be dedicated for use by a single processor 14 or shared between multiple processors 14, and/or subsystems (not shown) of the SoC 12. In an aspect, the cache memory 302 may be part of the processor 14, and may be dedicated for use by a single processor core or shared between multiple processor cores of the processor 14. The cache memory controller 300 may manage access to the cache memory 302 by various processors 14 and subsystems (not shown) of the SoC 12. The cache memory controller 300 may also manage memory access requests for access from the cache memory controller 300 to the main memory 306 and the storage memory 24 for retrieving memory contents that may be requested from the cache memory 302 by the processor 14, but not found in the cache memory 302 resulting in a cache miss.

The main memory 306 may be configured to temporarily store data and/or processor-executable code for quicker access than when accessing the storage memory 24. The main memory 306 may be available for access by the processors 14 of one or more SoCs 12, and/or subsystems (not shown) of the SoC 12. The main memory controller 304 may manage access to the main memory 306 by various processors 14 and subsystems (not shown) of the SoC 12 and computing device. The main memory controller 304 may also manage memory access requests for access by the main memory controller 304 to the storage memory 24 for retrieving memory contents that may be requested from the main memory 306 by the processor 14 or the cache memory controller 300, but not found in the main memory 305 resulting in a main memory miss.

The storage memory 24 may be configured to provide persistent storage of data and/or processor-executable code for retention when the computing device is not powered. The storage memory 24 may have the capacity to store more data and/or processor-executable code than the cache memory 302 and the main memory 306, and to store data and/or processor-executable code including those not being used or predicted for used in the near future by the processors 14 or subsystems (not shown) of the SoC 12. The storage memory 24 may be available for access by the processors 14 of one or more SoCs 12, and/or subsystems (not shown) of the SoC 12. The storage memory controller 308 may manage access to the storage memory 24 by various processors 14 and subsystems (not shown) of the SoC 12 and computing device. The storage memory controller 24 may also manage memory access requests for access from the cache memory controller 300 and the main memory controller 304 to the storage memory 24 for retrieving memory contents that may be requested from the cache memory 302 or the main memory 306 by the processor 14, but not found in the cache memory 302 or the main memory 305 resulting in a cache memory miss or a main memory miss.

The stream monitor 310 may be configured to monitor communications between the processor 14, subsystems of the SoC 12 (not shown), the cache memory controller 300, the main memory controller 300, and the storage memory controller 308. The stream monitor 310 may monitor these communications by monitoring the communication activity on one or more communications buses 312 connecting the processor 14 and/or the subsystems of the SoC 12 (not shown) to each of the controllers 300, 304, and 308.

Monitoring the communications between the components of the SoC 12 may include monitoring instruction request lines used to approximate execution events. The instruction request lines may be used to identify the requested processor-executable code of a memory access request to the memories 24, 302, and 306. Monitoring all instruction request lines may be overly taxing or inefficient in some implementation because not all the requested processor-executable code may be of interest for approximating or detecting execution events. So in an aspect, monitoring instruction request lines may be implemented selectively by determining processor-executable code of interest and an address in one or more of the memories 24, 302, and 306 associated with the processor-executable code.

The stream monitor 310 may monitor communications to the memories 24, 302, and 306 for accesses of memory regions containing the processor-executable code. The sizes and/or types of the memory regions may vary for different aspects, including a line, a block, a page, or any other memory unit size and/or type. In an aspect, the stream monitor 310 may monitor communications for memory access requests containing entry point addresses to the memories 24, 304, and 306. Identifying a memory access request including the entry point address may allow for identification of the processor-executable code requested for execution and identification of an execution event related to the processor-executable code. It should be understood that the entry point address is simply one example of many factors that may be used to identify the processor-executable code requested for execution. References to the entry point address in the descriptions of the various aspects are for example purposes only and are not meant to be limiting as to the factors that may be used to identify processor-executable code requested for execution.

In an aspect, monitoring the communications between the components of the SoC 12 may include monitoring instruction request lines, and using a combination of factors, to approximate or recognize certain execution events. In various aspects, the entry point address to the memories 24, 302, and 306 may not suffice to identify the processor-executable code requested for execution. For example, the memories 24, 302, and 306 may be divided into storage units, such as the various memory regions described above. The size of a memory region may vary for the different memories 24, 302, and 306. In an aspect where a memory region contains a single processor-executable code, the entry point address indicating a certain memory region may be sufficient to use for identifying the processor-executable code. In an aspect in which a memory region contains at least part of multiple processor-executable codes, the entry point address indicating a certain memory region may not be able to uniquely identify a single processor-executable code.

As demonstrated above, a factor for identifying the processor-executable code requested for execution may not always uniquely identify the processor-executable code. This may cause ambiguity identifying the processor-executable code requested for execution. In an aspect, the stream monitor 310 may employ at least two of the following factors to identify the processor-executable code of a memory access request:
Entry point address;
Exit point address;
Callee functions;
Caller functions;
Parameters (e.g., non-integers, buffers);
Unique instructions and patterns (e.g., loops);
Cache footprint (e.g. lines in the cache memory 302);
Local variables; and
Return value: whenever a return value is written, there is a chance that a new function call may happen.

The overhead cost of measuring the factor(s) for identifying the processor-executable code requested for execution may cause degradation of performance of the computing device for various tasks and resources. Such tasks may include general or specific processing, including identifying the processor-executable code requested for execution. The performance degradation on resource may include power availability. Substituting a factor(s) with lower overhead cost for the factor(s) with greater overhead cost may help reduce the performance degradation.

In an aspect, monitoring all, or even a portion of the communications between the components of the SoC 12 may be difficult. The number and speed of the communications may be beyond the capacity of the stream monitor 10. This may be especially true for monitoring communications to multiple memories 24, 302, and 306 when any of them have a multilevel memory hierarchy. The stream monitor 310 may lose track of processor-executable code that is moved around within in a multilevel memory hierarchy. In an aspect, the stream monitor 310 may mark a memory access request as non-storable for a given memory 302 and 306 in order to force a memory miss. The stream monitor 310 may monitor the access request to the other memory 24 and 306 resulting from the memory miss it forced. The stream monitor 310 may use the information obtained from monitoring the memory miss to follow future memory access requests for a processor-executable code, because this information may inform the stream monitor about where processor-executable code is located in the memories 24, 302, and 306.

In an aspect, the stream monitor 310 may identify the processor-executable code of a memory access request, regardless of whether there is a memory miss during the memory access request. The identified processor-executable code may be used to identify an execution event, which may prompt an API call. In an aspect, the execution event may be identified as unwanted or malicious, and the API call may be used to prevent further execution of the execution event. With the execution event blocked, at least temporarily, the source of the execution event may be identified and handled to prevent future execution of that execution event.

In an aspect, the above described process may be applied to monitoring memory access request for data, rather than for processor-executable code. Data producing components may be mapped to memory regions where the components read and write data. The stream monitor 310 may detect reads from the mapped memory region to verify the component or module that is reading the location, and also detect writes to the mapped memory region in case an attacker attempts to corrupt the data.

In an aspect, processor-executable code may reference to other processor-executable code and/or data stored in the memories 24, 302, and 306 using virtual addresses. For example, this is common when the processor-executable code is executed via a virtual machine run by the processor 14. However communications between some of the components of the SoC 12 via the communication buses 312 may identify locations in the memories 24, 302, and 306 using physical addresses. The stream monitor 310 may monitor memory access requests at various points, some using virtual addresses and some using physical addresses. The stream monitor 310, like other components of the SoC 12 may be configured to understand and use physical addresses to communicate among the components of the SoC 12.

In an aspect, the stream monitor 310 may also be configured to understand and use virtual addresses in its communications. An aspect of the stream monitor 310 handling virtual addresses may include use of a software component, which may be part of the operating system (OS) kernel, to perform translations from virtual addresses to physical addresses as needed by the stream monitor 310. In an aspect, a translation lookaside buffer (TLB) may be monitored during a memory access request to determine the physical address range, translated by the TLB, for monitoring. In response to the processor-executable code executing, the memory region for monitoring defined by the physical address range, may be stored on a content-addressable memory (CAM) array, and the addresses may be compared during a refill. In an aspect, code may be injected into each virtual address space to access the region for monitoring defined by the physical address range.

The stream monitor 310 may be implemented as software executed by the processor 14, as dedicated hardware, such as on a programmable processor device, or a combination of software and hardware modules. Some or all of the components of the SoC 12 may be differently arranged and/or combined while still serving the necessary functions. Moreover, the SoC 12 may not be limited to one of each of the components, and multiple instances of each component may be included in various configurations of the SoC 12. Aspect configurations of the SoC 12 may include components, such as the main memory controller 304, the main memory 306, and stream monitor 310 separate from, but connected to the SoC 12 via the communication buses 312.

FIG. 4 is an illustration of memory contents stored in various configurations relative to respective memory regions 402-412 in a memory 400 in accordance with an aspect. The memory 400 may be any of the above described memories, for example, the cache memory, the main memory, or the storage memory. The memory 400 may be divided into the memory regions 402-412. As discussed above, the memory regions 402-412 maybe be of any memory unit size and/or type, such as a line, a block, or a page. The memory regions 402-412 may be the memory unit size and/or type that may be used for memory access request in a respective computing device.

Memory contents stored in the memory 400 may include data and/or processor-executable code. For ease of explanation, and without limiting the scope of the description, the following examples are expressed in terms of processor-executable code. The memory regions 402-412 may contain one or more processor-executable codes (PECs) 414-424. For example, the memory region 402 may store a single processor-executable code (PEC 0) 414 within the boundaries of the memory region 402. In another example, the memory region 406 may store one or more processor-executable codes (PEC 1) 416, (PEC 2) 418 that may extend beyond the boundaries of memory region 406 into memory region 408. In another example, the memory region 410 may store multiple processor-executable codes (PEC 3) 420, (PEC 4) 422, and (PEC 5) 424 within the boundaries of the memory region 410.

In the case of memory region 402 storing a single processor-executable code (PEC 0) 414, the stream monitor may employ the aspect of selectively monitoring instruction request lines by determining processor-executable code of interest and an address in the memory 400 associated with that processor-executable code. The stream monitor may monitor communications to the memory 400 for accesses of memory region 402 containing the processor-executable code (PEC 0) 414. In this aspect, the stream monitor may monitor communications for a memory access request containing an entry point address to the memory 400 at memory region 402. The entry point address of the memory access request related to the memory region 402 may uniquely identify the processor-executable code (PEC 0) 414, as the processor-executable code (PEC 0) 414 is the only processor-executable code to reside in the memory region 402. Therefore, the stream monitor may identify when the processor-executable code (PEC 0) 414 is called for execution by the processor by monitoring a memory access request for the memory region 402.

The above described aspect applied for monitoring memory region 402 may not be as accurate in identifying the processor-executable code that is being retrieved for execution by the processor when a memory access request involves memory regions 406, 410. Since each of memory regions 406, 410 may store multiple processor-executable codes 416-424, identifying the memory region related to the entry point address of the memory access request may lead to false positives.

One such false positive may include the identification of multiple processor-executable codes 416-424 of a respective memory region 406, 410 when less than all of the processor-executable codes 416-424 of the respective memory region 406, 410 are retrieved for execution. In this example, while multiple processor-executable codes 416-424 may be retrieved in response to the memory access request, not all of them may be executed. Another false positive may result from identifying processor-executable codes 416-424 know to be stored in one of memory regions 406, 410 accidentally, when the processor-executable code 416-424 being retrieved for execution is not known to be in the same memory region 406, 410. These examples of false positives are similar, except that in the first example a target processor-executable code 416-424 may be identified along with other processor-executable codes 416-424, and in the second example only other processor-executable codes 416-424 may be identified. Therefore, relying on the entry point address of the memory access request alone may produce overly inclusive or incomplete information.

Identifying the processor-executable code that is being retrieved from memory regions 406, 410 may employ the aspect of using a combination of factors, as illustrated in the examples provided above. Since the entry point address alone may produce overly inclusive or incomplete information, use of other factors may enable the stream monitor to identify a specific processor-executable code 416-424 from the group of other processor-executable codes 416-424 stored in the same memory region 406, 410. While unnecessary, this aspect may also be used to identify the single processor-executable codes (PEC 0) 414 stored in memory region 402.

In an example, using the entry point address and the exit point address of the memory access may be used to identify processor-executable code (PEC 2). Since processor-executable code (PEC 2) 418 is partially stored in memory region 406 and in memory region 408, the entry point address and exit point address may be associated with a respective memory region 406, 408. Among any of the processor-executable codes 416, 418 stored in memory regions 406, 408, the combination of an entry point address associated with memory region 406 and an exit point address associated with memory region 408 is unique to processor-executable code (PEC 2) 418.

The other factors may be applied to identify any of the processor-executable codes 416-424. For example, any of the factors may be predetermined to be associated with one or more processor-executable codes 416-424. The stream monitor may be configured to identify any combination of the factors. In response to a memory access request, the stream monitor may identify the factors and compare the factors to the processor-executable codes 416-424 with which they are related. For any two or more factors identified by the stream monitor, the processor-executable codes 416-424 associated with each of the identified factors may be the processor-executable code 416-424 targeted by the memory access request. The stream monitor may be configured such that the factors it identifies are selected for uniquely identifying one of the processor-executable codes 416-424.

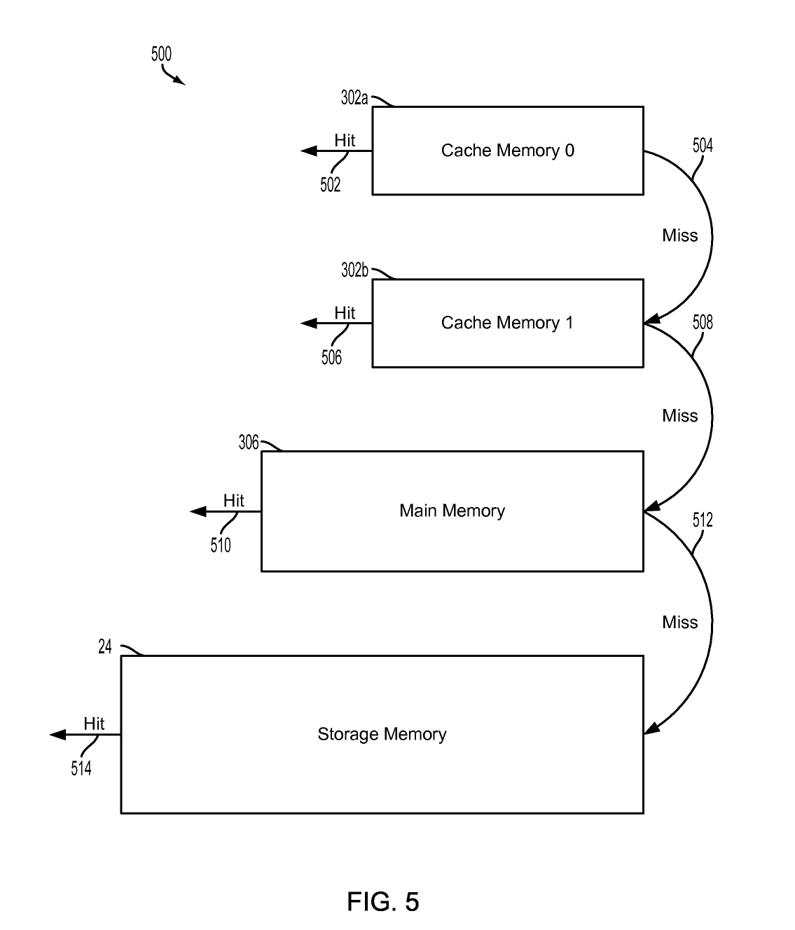

FIG. 5 is an illustration of an interaction of memories in a memory hierarchy 500 monitored by the stream monitor in accordance with an aspect. The memory hierarchy 500 may include multiple levels of memory, such as multiple levels of cache memory (cache memory 0) 302a, (cache memory 1) 302b, the main memory 306, and the storage device 24. Each memory access request monitored by the stream monitor may result in a hit or a miss for the memory 24, 302a, 302b, and 306 targeted by the memory access request. A hit may result from a successful memory access request, such that the memory location of the memory access request is populated and the memory contents are returned 502, 506, 510, 514. A miss may result from an unsuccessful memory access request, such that the memory location of the memory access request is not populated. For a miss, rather than returning the memory contents requested by the memory access request, a supplemental memory access request 504, 508, 512 may be made to a lower level of the memory hierarchy 500. The supplemental memory access request may be made by the memory 302a, 302b, and 306 (or its respective controller) at which the memory access request missed.

The stream monitor may monitor each memory access request, supplemental memory access request 504, 508, 512, and memory contents return 502, 506, 510, 514. A memory access request may target any of the memories 24, 302a, 302b, 306 in the memory hierarchy 500. In an example, a memory access request may target cache memory 0 302a. In response to a hit the request memory contents may be returned 502. In response to a miss, a supplemental memory access request 504, for the same memory contents, may be made to the next lower level in the memory hierarchy 500, cache memory 1 302b. The stream monitor may monitor the output of the cache memory 0 302a for the return 502 or the supplemental memory access request 504. In response to the return 502, the stream monitor may identify the information it may use to estimate an execution event. In response to the supplemental memory access request 504 to the cache memory 1 302b, the stream monitor may monitor the output of the cache memory 1 302b. The supplemental access requests 504, 508, 512 may occur for each level of memory in the memory hierarchy 500, as long as there is a next lower level, until one results in a hit. The stream monitor may monitor the output of the memories 24, 302b, 306 receiving a supplemental memory access request 504, 508, 512. A supplemental memory access request may be directed to any lower level of memory in the memory hierarchy 500, and does not have to be directed only to the next lower level.

In an aspect, once memory content is stored to one of the cache memories 302a, 302b, the stream monitor may loses track of the memory content until the memory content is evicted. The stream monitor may not be configured to monitor all of the memory levels of the memory hierarchy 500. Memory contents returns 502, 506 may be missed by the stream monitor. A memory access request, which may include supplemental memory access request 504, may be sent to a cache memory 302a, 302b that the stream monitor does not monitor. The stream monitor may mark the memory access request as non-cacheable. This may force a miss at the targeted cache memory 302a, 302b so that the stream monitor may monitor the supplemental memory access request 504, 508, 512, and the potential memory contents return 506, 510, 514, from a memory 24, 302b, 306 that the stream monitor may be configured to monitor. Marking the memory access request as non-cacheable may be repeated for each instance of the memory access request, or may be persistent, for example, by saving the marking to a controller of the targeted cache memory 302a, 302b. Marking the memory access request as non-cacheable may be implemented at any level of memory of the memory hierarchy 500. However, doing so at lower levels of the memory hierarchy 500, such as the main memory 306, or a lowest level of cache memory, cache memory 1 302b in the examples herein, may cause performance degradations. To avoid such performance degradations the stream monitor may avoid marking memory access requests to the lower memory levels as un-cacheable.

The memories 24, 302a, 302b, 306 referred to in these examples are not meant to be limiting in number or configuration. The memory hierarchy 500 may have a variety of configurations including more or fewer of any of cache, main, and storage, memories of varying types, sizes, and speeds. The memory hierarchy 500 may also be configured to have multiple memories 24, 302a, 302b, 306 share the same memory level.

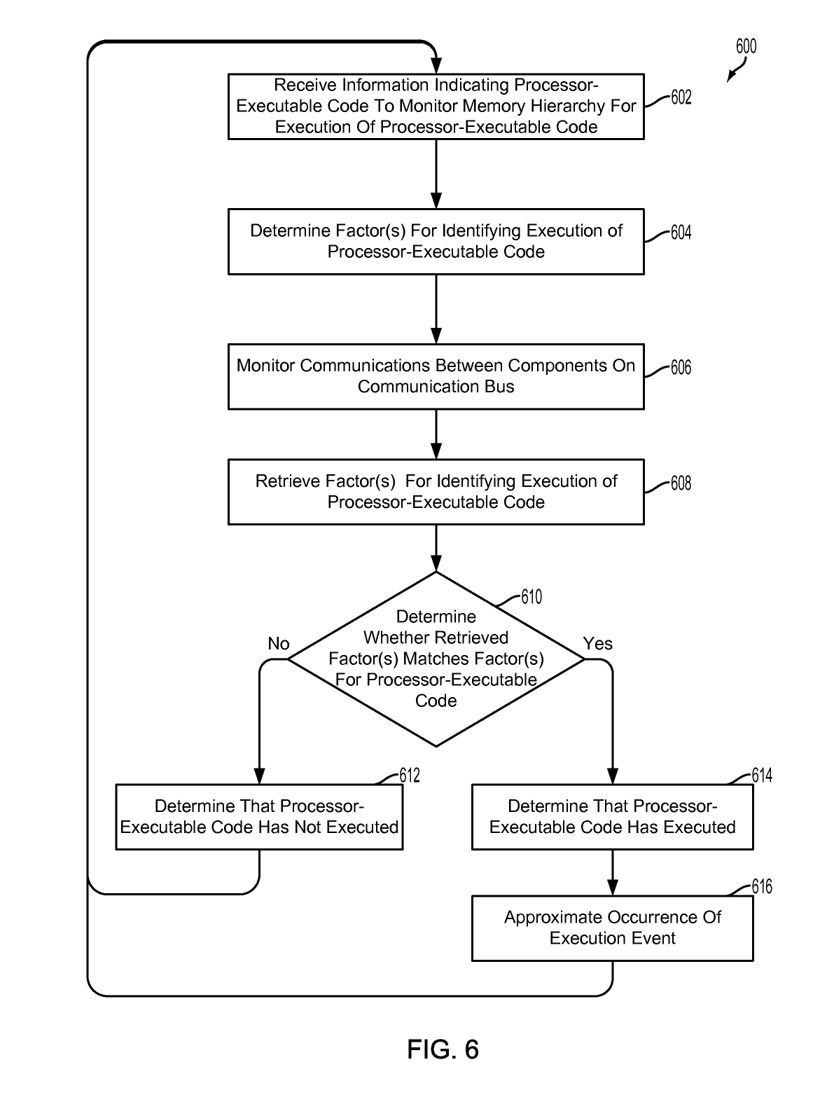

FIG. 6 illustrates an aspect method 600 for implementing an approximation of execution events using memory hierarchy monitoring. The method 600 may be executed in a computing device using software, general purpose or dedicated hardware, such as the processor and/or the stream monitor, or a combination of software and hardware. In block 602, the computing device may receive information identifying processes to look for by monitoring the memory hierarchy and the factors that the processor can use to identify when those processes are executing. This received information may identify the processes that are the subject of such monitoring as processor-executable code that may be executed by the computing device. In an aspect, the computing device may determine whether an execution event occurs by recognizing when the identified processor-executable code is the target of a memory access request. The information indicating the processor-executable code the execution of which is to be recognized via monitoring the memory hierarchy may be preprogrammed on the computing device or provided to the computing device by a software program running on the computing device. The processor-executable code that is the subject of such monitoring may be related to functions of the computing device that may correlate to execution events on the computing device that are not authorized by a user, or by software selected for execution by the user or a system of the computing device.

In block 604, the computing device may determine the factor(s) to be used for identifying the processor-executable code that may be executed in response to the memory access request. As described above, one or more factors may be used to identify the processor-executable code that is the target of a memory access request. Such factors may include, for example, an entry point address, an exit point address, callee functions, caller functions, parameters (e.g., non-integers, buffers), unique instructions and patterns (e.g., loops), cache footprint (e.g. lines in the cache memory), local variables, and return values. In various aspects, any one factor, such as the entry point address, or combination of factors may be used to uniquely identify the processor-executable code that is the target of a memory access request. As with the identification of the processor-executable code in block 602, the determination of the factor(s) to be used for identifying or recognizing the processor-executable code may be preprogrammed on the computing device or provided to the computing device by a software program running on the computing device.

In block 606, the computing device may monitor communications between components connected to the communication buses. Examples of such communications include memory access requests, supplemental memory access requests between memories used when there is a miss at a memory, and return values in response to the various types of memory access requests. The computing device may monitor the communications for the information relating to the factor(s) that it may use to identify whether a certain processor-executable code is accessed from memory for execution by the computing device. In block 608 the computing device may retrieve the information relating to the factor(s) from the monitored communications for identifying whether the certain processor-executable code is accessed from memory for execution by the computing device. In an aspect, the computing device may be configured to retrieve only the information relating to the factor(s) determined for identifying the certain processor-executable code. In another aspect, the computing device may be configured to retrieve all of the information of a communication on the communication buses, and to parse out the information relating to the factor(s) determined for identifying the certain processor-executable code.

In determination block 610, the computing device may determine whether the information relating to the factor(s) retrieved from the monitored communication matches the factor(s) determined for identifying the certain processor-executable code. The computing device may compare values of the factor(s) of the target of a memory access request with the information relating to the factor(s) of the monitored communication.

In response to determining that the retrieved information relating to the factor(s) of the monitored communication do not match the factor(s) determined to be indicative of the certain processor-executable code (i.e. determination block 610=“No”), the computing device may determine that the certain processor-executable code is not being executed by the computing device in block 612. In other words, the target memory contents of the monitored memory access request are not the processor-executable code of interest.

In response to determining that the retrieved information relating to the factor(s) of the monitored communication match the factor(s) determined to be indicative of the certain processor-executable code (i.e. determination block 610=“Yes”), the computing device may determine that the certain processor-executable code is being executed by the computing device in block 614. In other words, the target memory contents of the monitored memory access request are the processor-executable code of interest. In block 616, the computing device may approximate the occurrence of an execution event based on the determination that the certain processor-executable code is being executed and the certain processor-executable code's relation to the execution event.

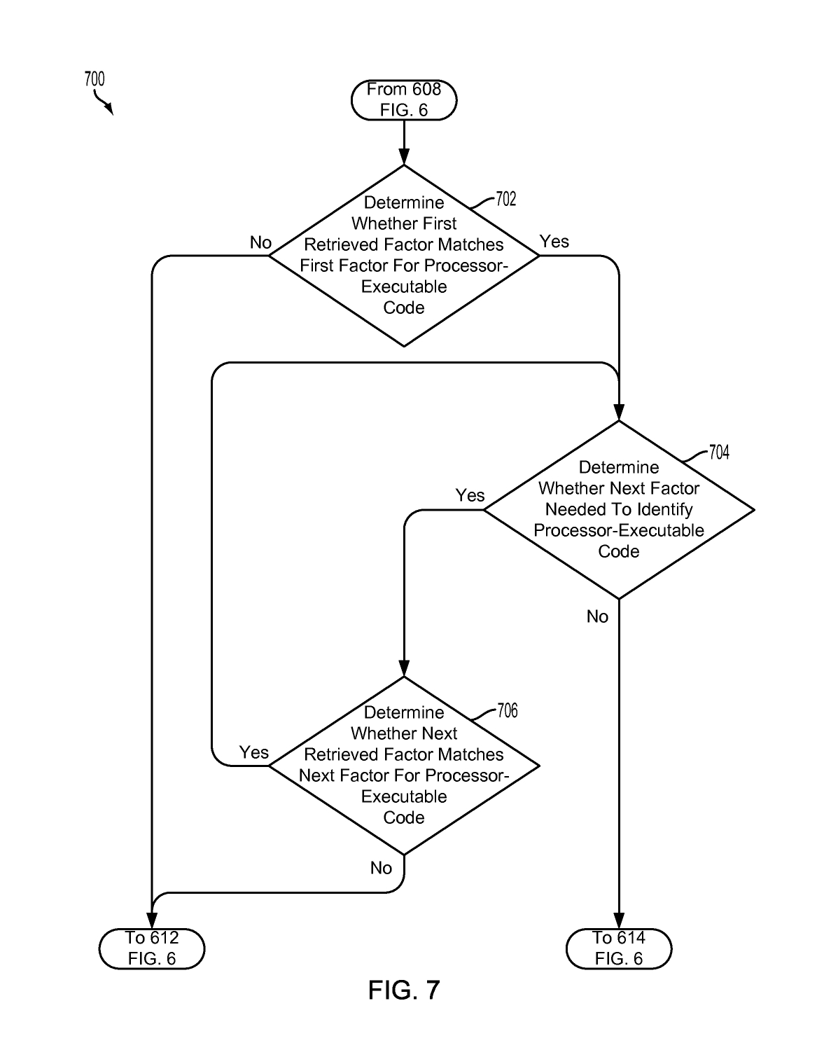

FIG. 7 illustrates an aspect method 700 for identifying memory contents of a monitored memory access request. The method 700 may be executed in a computing device using software, general purpose or dedicated hardware, such as the processor and/or the stream monitor, or a combination of software and hardware. The method 700 includes an embodiment of operations that may be implemented indetermination block 610 of method 600 described above.

In determination block 702, the computing device may determine whether a first retrieved information relating to a first factor of the monitored communication matches a first factor determined for identifying the certain processor-executable code. The first factor may be any factor that may be used for identifying the certain processor-executable code as the target memory contents of the monitored memory access request. For example, the first factor may be the entry point address of the memory access request as the entry point address may be used by itself to uniquely identify the certain processor-executable code.

In response to determining that the first retrieved information relating to the first factor of the monitored communication does not match the first factor determined for identifying the certain processor-executable code (i.e. determination block 702=“No”), the computing device may determine that the certain processor-executable code is not executed by the computing device in block 612.

In response to determining that the first retrieved information relating to the first factor of the monitored communication does match the first factor determined for identifying the certain processor-executable code (i.e. determination block 702=“Yes”), the computing device may determine whether a next factor is needed to identify the certain processor-executable code in determination block 704. As described above, identifying a processor-executable code as the target of the monitored memory access request may require a combination of factors when a single factor may result in ambiguity or false positives for other processor-executable codes. In other words, the factor may not uniquely identify the certain processor-executable code. The next factor may be any of the factors that have not already been used to identify the certain processor-executable code. In an aspect, the determination of whether a next factor is needed may be based on the overhead of measuring the factors. For example, in response to a factor being too costly to monitor, a next factor that is less costly to monitor while providing suitable recognition of the certain code may be monitored instead. Such a substitute factor may be monitored alone or in conjunction with another factor(s) to identify the certain processor-executable code. A determination that the overhead of a factor is too costly to monitor may be based on whether the overhead for monitoring the factor exceeds a threshold.

In response to determining that the next factor is not needed to identify the certain processor-executable code (i.e. determination block 704=“No”), the computing device may determine that the certain processor-executable code is executed by the computing device in block 614.

In response to determining that the next factor is needed to identify the certain processor-executable code (i.e. determination block 704=“Yes”), the computing device may determine whether the next retrieved information relating to the next factor of the monitored communication matches the next factor determined for identifying the certain processor-executable code in determination block 706. In response to determining that the next retrieved information relating to the next factor of the monitored communication does not match the next factor determined for identifying the certain processor-executable code (i.e. determination block 706=“No”), the computing device may determine that the certain processor-executable code is not executed by the computing device in block 612. In response to determining that the next retrieved information relating to the next factor of the monitored communication does match the next factor determined for identifying the certain processor-executable code (i.e. determination block 706=“Yes”), the computing device may determine whether a next factor is needed to identify the certain processor-executable code in determination block 704 as described above.

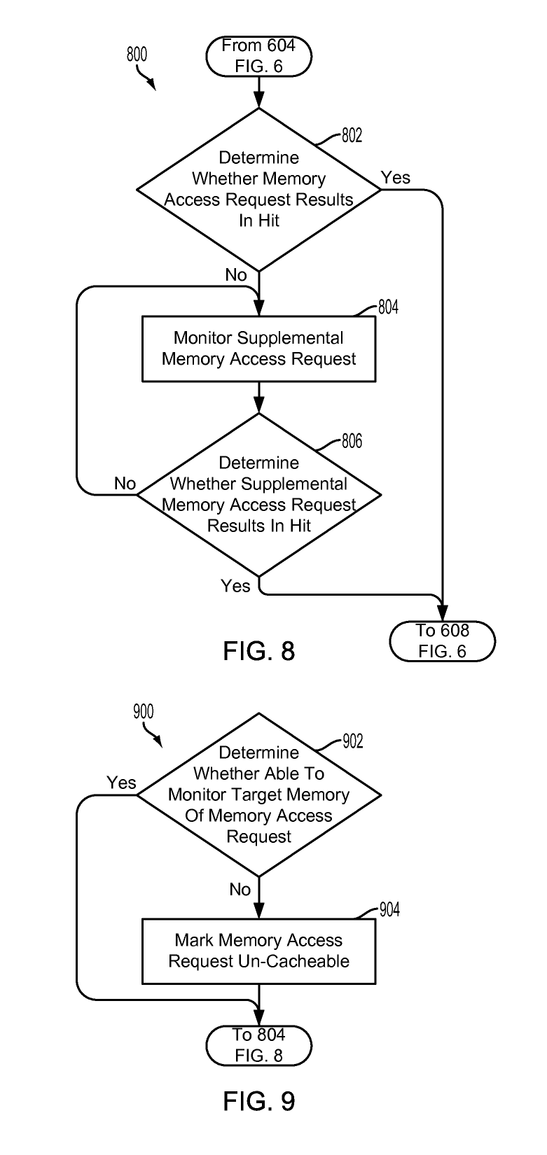

FIG. 8 illustrates an aspect method 800 for monitoring a memory access request resulting in a hit or a miss. The method 800 may be executed in a computing device using software, general purpose or dedicated hardware, such as the processor and/or the stream monitor, or a combination of software and hardware. The method 800 includes an embodiment of operations that may be implemented in block 606 of method 500 described above.

In determination block 802, the computing device may determine whether a monitored memory access request results in a hit. In other words, the computing device may determine whether the target memory content of the monitored memory access is located at the location of the memory specified by the monitored memory access request. The monitored memory access request may alternatively result in a miss, such that the target memory content of the monitored memory access is not located at the location of the memory specified by the monitored memory access request. In response to determining that the monitored memory access request results in a hit (i.e. determination block 802=“Yes”), in block 608 the computing device may retrieve the information relating to the factor(s) from the monitored communications for identifying whether the certain processor-executable code is accessed from memory for execution by the computing device.

In response to determining that the monitored memory access request results in a miss (i.e. determination block 802=“Yes”), the computing device may monitor a supplemental memory access request for the target memory contents in another memory in block 804. A miss for the monitored memory access request may prompt the computing device to generate a supplemental memory access request to another memory that may be at a lower level in the memory hierarchy of the computing device. The computing device may monitor the supplemental memory access request in much that same way that it may monitor the memory access request.

In determination block 806, the computing device may determine whether the supplemental memory access request results in a hit. In response to determining that the supplemental memory access request results in a hit (i.e. determination block 806=“Yes”), in block 608 the computing device may retrieve the information relating to the factor(s) from the monitored communications for identifying whether the certain processor-executable code is accessed from memory for execution by the computing device. In response to determining that the supplemental memory access request results in a miss (i.e. determination block 806=“No”), the computing device may monitor a supplemental memory access request for the target memory contents in another memory in block 804. A miss for the supplemental memory access request may prompt the computing device to generate another supplemental memory access request to another memory that may be at a lower level in the memory hierarchy of the computing device. Supplemental memory access requests may continue to be generated by the computing device as long as there is a lower level in the memory hierarchy of the computing device to target with the supplemental memory access request.

FIG. 9 illustrates an aspect method 900 for monitoring a memory access request targeting a memory that is not monitored. The method 900 may be executed in a computing device using software, general purpose or dedicated hardware, such as the processor and/or the stream monitor, or a combination of software and hardware. In determination block 902, the computing device may determine whether it is able to monitor a target memory of a memory access request. As described above, in computing devices with multi-leveled memory hierarchies, the computing device may not always be configured to monitor the inputs and outputs of each level of the memory hierarchy. As such, some of the information relating to the factor(s) for identifying a processor-executable code of a memory access request may not be retrieved by the computing device. Without the information, the computing device may not be able to accurately identify the processor-executable code of the memory access request.

In response to determining that the computing device can monitor the target memory of the memory access request (i.e. determination block 902=“Yes”), the computing device may monitor communications between components connected to the communication buses in block 606 as described above.

In response to determining that the computing device cannot monitor the target memory of the memory access request (i.e. determination block 902=“No”), the computing device may mark a memory access request targeting the target memory that cannot be monitored as un-cacheable in block 904. Marking the memory access request un-cacheable may force a miss at the target memory, and the computing device may monitor a supplemental memory access request for the target memory contents in another memory in block 804 as described above.

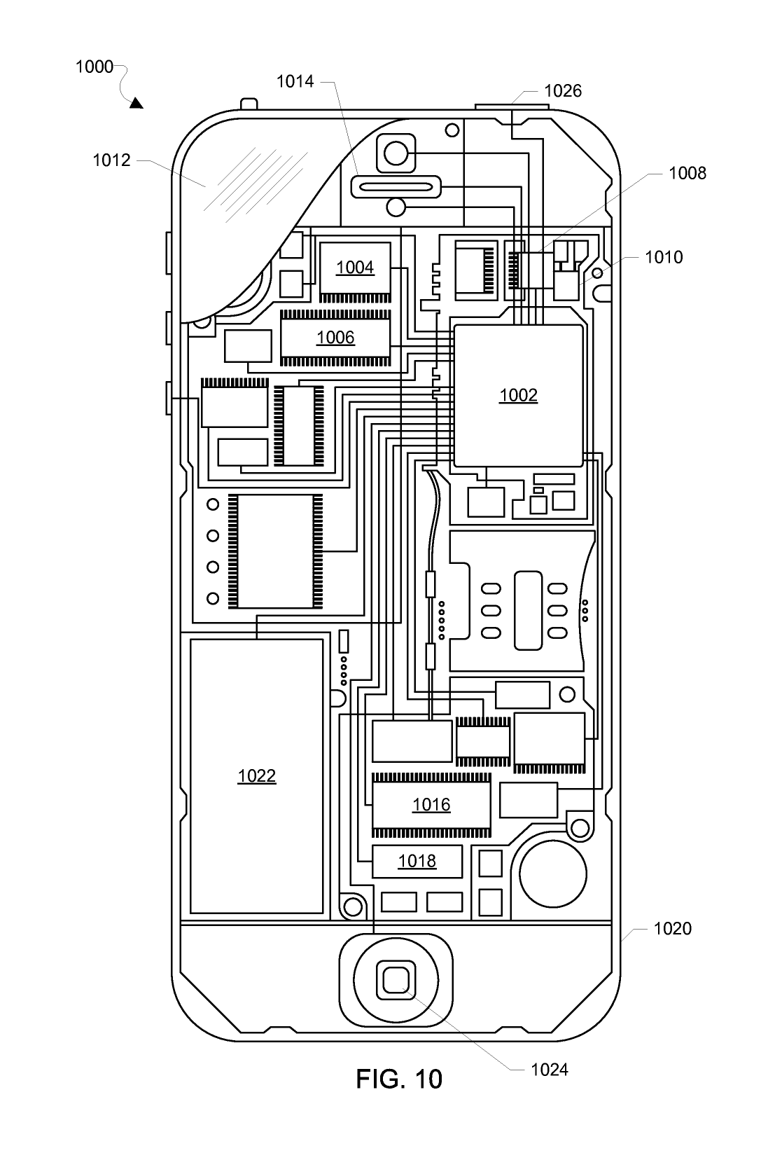

The various aspects (including, but not limited to, aspects discussed above with reference to FIGS. 1-9) may be implemented in a wide variety of computing systems, which may include an example mobile computing device suitable for use with the various aspects illustrated in FIG. 10. The mobile computing device 1000 may include a processor 1002 coupled to a touchscreen controller 1004 and an internal memory 1006. The processor 1002 may be one or more multicore integrated circuits designated for general or specific processing tasks. The internal memory 1006 may be volatile or non-volatile memory, and may also be secure and/or encrypted memory, or unsecure and/or unencrypted memory, or any combination thereof. Examples of memory types that can be leveraged include but are not limited to DDR, LPDDR, GDDR, WIDEIO, RAM, SRAM, DRAM, P-RAM, R-RAM, M-RAM, STT-RAM, and embedded DRAM. The touchscreen controller 1004 and the processor 1002 may also be coupled to a touchscreen panel 1012, such as a resistive-sensing touchscreen, capacitive-sensing touchscreen, infrared sensing touchscreen, etc. Additionally, the display of the computing device 1000 need not have touch screen capability.

The mobile computing device 1000 may have one or more radio signal transceivers 1008 (e.g., Peanut, Bluetooth, Zigbee, Wi-Fi, RF radio) and antennae 1010, for sending and receiving communications, coupled to each other and/or to the processor 1002. The transceivers 1008 and antennae 1010 may be used with the above-mentioned circuitry to implement the various wireless transmission protocol stacks and interfaces. The mobile computing device 1000 may include a cellular network wireless modem chip 1016 that enables communication via a cellular network and is coupled to the processor.

The mobile computing device 1000 may include a peripheral device connection interface 1018 coupled to the processor 1002. The peripheral device connection interface 1018 may be singularly configured to accept one type of connection, or may be configured to accept various types of physical and communication connections, common or proprietary, such as USB, FireWire, Thunderbolt, or PCIe. The peripheral device connection interface 1018 may also be coupled to a similarly configured peripheral device connection port (not shown).

The mobile computing device 1000 may also include speakers 1014 for providing audio outputs. The mobile computing device 1000 may also include a housing 1020, constructed of a plastic, metal, or a combination of materials, for containing all or some of the components discussed herein. The mobile computing device 1000 may include a power source 1022 coupled to the processor 1002, such as a disposable or rechargeable battery. The rechargeable battery may also be coupled to the peripheral device connection port to receive a charging current from a source external to the mobile computing device 1000. The mobile computing device 1000 may also include a physical button 1024 for receiving user inputs. The mobile computing device 1000 may also include a power button 1026 for turning the mobile computing device 1000 on and off.

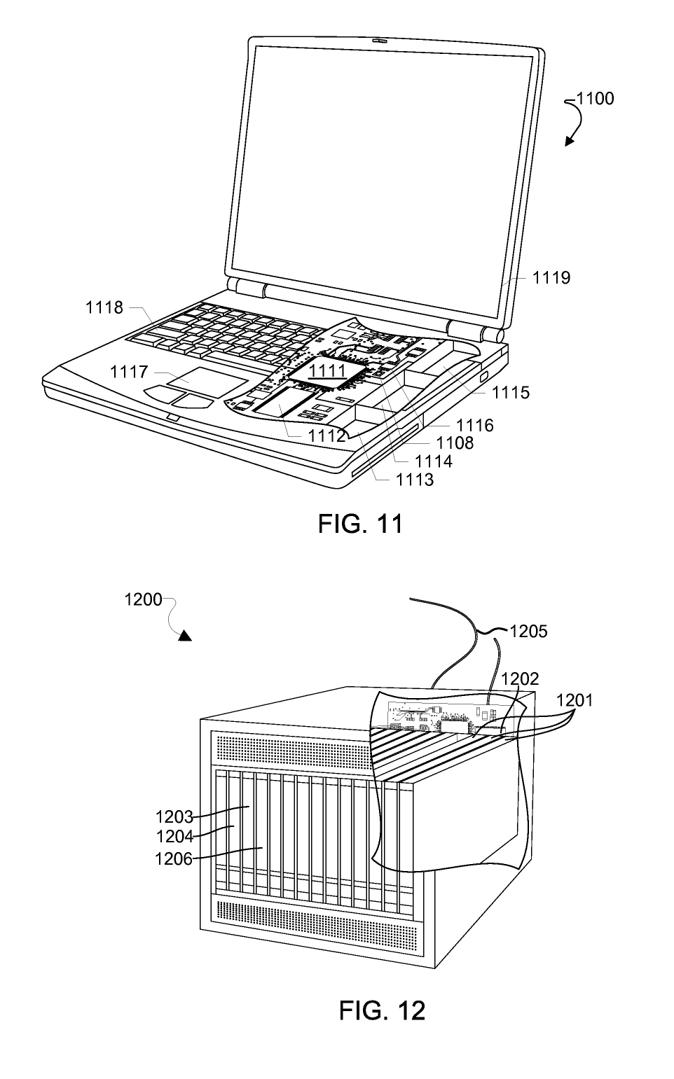

The various aspects (including, but not limited to, aspects discussed above with reference to FIGS. 1-9) may be implemented in a wide variety of computing systems, which may include a variety of mobile computing devices, such as a laptop computer 1100 illustrated in FIG. 11. Many laptop computers include a touchpad touch surface 1117 that serves as the computer's pointing device, and thus may receive drag, scroll, and flick gestures similar to those implemented on computing devices equipped with a touch screen display and described above. A laptop computer 1100 will typically include a processor 1111 coupled to volatile memory 1112 and a large capacity nonvolatile memory, such as a disk drive 1113 of Flash memory. Additionally, the computer 1100 may have one or more antenna 1108 for sending and receiving electromagnetic radiation that may be connected to a wireless data link and/or cellular telephone transceiver 1116 coupled to the processor 1111. The computer 1100 may also include a floppy disc drive 1114 and a compact disc (CD) drive 1115 coupled to the processor 1111. In a notebook configuration, the computer housing includes the touchpad 1117, the keyboard 1118, and the display 1119 all coupled to the processor 1111. Other configurations of the computing device may include a computer mouse or trackball coupled to the processor (e.g., via a USB input) as are well known, which may also be used in conjunction with the various aspects.

The various aspects (including, but not limited to, aspects discussed above with reference to FIGS. 1-9) may be implemented in a wide variety of computing systems, which may include any of a variety of commercially available servers for compressing data in server cache memory. An example server 1200 is illustrated in FIG. 12. Such a server 1200 typically includes one or more multi-core processor assemblies 1201 coupled to volatile memory 1202 and a large capacity nonvolatile memory, such as a disk drive 1204. As illustrated in FIG. 12, multi-core processor assemblies 1201 may be added to the server 1200 by inserting them into the racks of the assembly. The server 1200 may also include a floppy disc drive, compact disc (CD) or DVD disc drive 1206 coupled to the processor 1201. The server 1200 may also include network access ports 1203 coupled to the multi-core processor assemblies 1201 for establishing network interface connections with a network 1205, such as a local area network coupled to other broadcast system computers and servers, the Internet, the public switched telephone network, and/or a cellular data network (e.g., CDMA, TDMA, GSM, PCS, 3G, 4G, LTE, or any other type of cellular data network).

Computer program code or “program code” for execution on a programmable processor for carrying out operations of the various aspects may be written in a high level programming language such as C, C++, C#, Smalltalk, Java, JavaScript, Visual Basic, a Structured Query Language (e.g., Transact-SQL), Perl, or in various other programming languages. Program code or programs stored on a computer readable storage medium as used in this application may refer to machine language code (such as object code) whose format is understandable by a processor.

Many computing devices operating system kernels are organized into a user space (where non-privileged code runs) and a kernel space (where privileged code runs). This separation is of particular importance in Android and other general public license (GPL) environments in which code that is part of the kernel space must be GPL licensed, while code running in the user-space may not be GPL licensed. It should be understood that the various software components/modules discussed here may be implemented in either the kernel space or the user space, unless expressly stated otherwise.

The foregoing method descriptions and the process flow diagrams are provided merely as illustrative examples and are not intended to require or imply that the operations of the various aspects must be performed in the order presented. As will be appreciated by one of skill in the art the order of operations in the foregoing aspects may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the various aspects may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed aspects is provided to enable any person skilled in the art to make or use the present invention. Various modifications to these aspects will be readily apparent to those skilled in the art, and the generic principles defined herein may be applied to other aspects without departing from the spirit or scope of the invention. Thus, the present invention is not intended to be limited to the aspects shown herein but is to be accorded the widest scope consistent with the following claims and the principles and novel features disclosed herein.

What is claimed is:

1. A method for monitoring communications between components and a memory hierarchy of a computing device, comprising:
determining an identifying factor for identifying execution of a processor-executable code;
monitoring a communication factor in a communication between the components and the memory hierarchy of the computing device of a same type as the identifying factor;
determining whether a value of the identifying factor matches a value of the communication factor; and
determining that the processor-executable code is executed in response to determining that the value of the identifying factor matches the value of the communication factor.

2. The method of claim 1, wherein determining whether a value of the identifying factor matches a value of the communication factor comprises:
determining whether a value of a first identifying factor matches a value of a first communication factor;
determining whether a second identifying factor is needed to identify execution of the processor-executable code; and
determining whether a value of the second identifying factor matches a value of a second communication factor in response to determining that the second identifying factor is needed to identify execution of the processor-executable code.

3. The method of claim 2, further comprising:
determining whether another identifying factor is need to identify execution of the processor-executable code in response to determining that the value of the second identifying factor matches the value of the second communication factor.

4. The method of claim 2, wherein:
a type of the first identifying factor and the first communication factor is different from a type of the second identifying factor and the second communication factor; and
determining whether a second identifying factor is need to identify execution of the processor-executable code comprises determining whether the second identifying factor is need to identify execution of the processor-executable code in response to in response to determining that the value of the first identifying factor matches the value of the first communication factor, the value of the first communication factor not uniquely identifying the processor-executable code, or an overhead for monitoring the first communication factor exceeds a threshold.

5. The method of claim 1, further comprising determining that the processor-executable code is not executed in response to determining that the value of the identifying factor does not match the value of the communication factor.

6. The method of claim 1, wherein monitoring for a communication factor in a communication between the components and the memory hierarchy of the computing device of a same type as the identifying factor comprises:
determining whether a memory access request to a first target memory of the memory hierarchy results in a miss; and
monitoring a supplemental memory access request to a second target memory of a lower level of the memory hierarchy in response to determining that the memory access request results in a miss.

7. The method of claim 1, wherein the communication is associated with a target memory of the memory hierarchy, the method further comprising:
determining whether the communication can be monitored; and
marking the communication un-cacheable in response to determining that the communication cannot be monitored.

8. The method of claim 1, wherein a type of the identifying factor and the communication factor comprises one of an entry point address of a target memory, an exit point address of a target memory, a callee function, a caller function, a parameter, a unique instruction, a unique pattern, a cache footprint, a local variable, and a return value.

9. A computing device, comprising a stream monitor configured with stream monitor-executable instructions to perform operations comprising:
determining an identifying factor for identifying execution of a processor-executable code;
monitoring a communication factor in a communication between components of the computing device and a memory hierarchy of the computing device of a same type as the identifying factor;
determining whether a value of the identifying factor matches a value of the communication factor; and
determining that the processor-executable code is executed in response to determining that the value of the identifying factor matches the value of the communication factor.

10. The computing device of claim 9, wherein the stream monitor is configured with stream monitor-executable instructions to perform operations such that determining whether a value of the identifying factor matches a value of the communication factor comprises:
determining whether a value of a first identifying factor matches a value of a first communication factor;
determining whether a second identifying factor is needed to identify execution of the processor-executable code; and
determining whether a value of the second identifying factor matches a value of a second communication factor in response to determining that the second identifying factor is needed to identify execution of the processor-executable code.

11. The computing device of claim 10, wherein the stream monitor is configured with stream monitor-executable instructions to perform operations further comprising:
determining whether another identifying factor is need to identify execution of the processor-executable code in response to determining that the value of the second identifying factor matches the value of the second communication factor.

12. The computing device of claim 10, wherein:
a type of the first identifying factor and the first communication factor is different from a type of the second identifying factor and the second communication factor; and
the stream monitor is configured with stream monitor-executable instructions to perform operations such that determining whether a second identifying factor is need to identify execution of the processor-executable code comprises determining whether the second identifying factor is need to identify execution of the processor-executable code in response to in response to determining that the value of the first identifying factor matches the value of the first communication factor, the value of the first communication factor not uniquely identifying the processor-executable code, or an overhead for monitoring the first communication factor exceeds a threshold.

13. The computing device of claim 9, wherein the stream monitor is configured with stream monitor-executable instructions to perform operations further comprising determining that the processor-executable code is not executed in response to determining that the value of the identifying factor does not match the value of the communication factor.

14. The computing device of claim 9, wherein the stream monitor is configured with stream monitor-executable instructions to perform operations such that monitoring for a communication factor in a communication between the components and the memory hierarchy of the computing device of a same type as the identifying factor comprises:
determining whether a memory access request to a first target memory of the memory hierarchy results in a miss; and
monitoring a supplemental memory access request to a second target memory of a lower level of the memory hierarchy in response to determining that the memory access request results in a miss.

15. The computing device of claim 9, wherein the stream monitor is configured with stream monitor-executable instructions to perform operations such that the communication is associated with a target memory of the memory hierarchy, and wherein the processor is configured with processor-executable instructions to perform operations further comprising:
determining whether the communication can be monitored; and
marking the communication un-cacheable in response to determining that the communication cannot be monitored.

16. The computing device of claim 9, wherein the stream monitor is configured with stream monitor-executable instructions to perform operations such that a type of the identifying factor and the communication factor comprises one of an entry point address of a target memory, an exit point address of a target memory, a callee function, a caller function, a parameters, a unique instruction, a unique pattern, a cache footprint, a local variable, and a return value.

17. A computing device, comprising:
means for determining an identifying factor for identifying execution of a processor-executable code;
means for monitoring a communication factor in a communication between one or more components of the computing device and a memory hierarchy of the computing device of a same type as the identifying factor;
means for determining whether a value of the identifying factor matches a value of the communication factor; and
means for determining that the processor-executable code is executed in response to determining that the value of the identifying factor matches the value of the communication factor.

18. The computing device of claim 17, wherein means for determining whether a value of the identifying factor matches a value of the communication factor comprises:
means for determining whether a value of a first identifying factor matches a value of a first communication factor;
means for determining whether a second identifying factor is needed to identify execution of the processor-executable code; and
means for determining whether a value of the second identifying factor matches a value of a second communication factor in response to determining that the second identifying factor is needed to identify execution of the processor-executable code.

19. The computing device of claim 18, further comprising:
means for determining whether another identifying factor is need to identify execution of the processor-executable code in response to determining that the value of the second identifying factor matches the value of the second communication factor.

20. The computing device of claim 18, wherein:
a type of the first identifying factor and the first communication factor is different from a type of the second identifying factor and the second communication factor; and
means for determining whether a second identifying factor is need to identify execution of the processor-executable code comprises means for determining whether the second identifying factor is need to identify execution of the processor-executable code in response to in response to determining that the value of the first identifying factor matches the value of the first communication factor, the value of the first communication factor not uniquely identifying the processor-executable code, or an overhead for monitoring the first communication factor exceeds a threshold.

21. The computing device of claim 17, wherein means for monitoring for a communication factor in a communication between the components and the memory hierarchy of the computing device of a same type as the identifying factor comprises:
means for determining whether a memory access request to a first target memory of the memory hierarchy results in a miss; and
means for monitoring a supplemental memory access request to a second target memory of a lower level of the memory hierarchy in response to determining that the memory access request results in a miss.

22. The computing device of claim 17, wherein the communication is associated with a target memory of the memory hierarchy, the computing device further comprising:
means for determining whether the communication can be monitored; and
means for marking the communication un-cacheable in response to determining that the communication cannot be monitored.

23. The computing device of claim 17, wherein a type of the identifying factor and the communication factor comprises one of an entry point address of a target memory, an exit point address of a target memory, a callee function, a caller function, a parameters, a unique instruction, a unique pattern, a cache footprint, a local variable, and a return value.

24. A non-transitory processor-readable storage medium having stored thereon processor-executable instructions configured to cause a processor of a computing device to perform operations comprising:
determining an identifying factor for identifying execution of a processor-executable code;
monitoring a communication factor in a communication between components and a memory hierarchy of the computing device of a same type as the identifying factor;
determining whether a value of the identifying factor matches a value of the communication factor; and
determining that the processor-executable code is executed in response to determining that the value of the identifying factor matches the value of the communication factor.

25. The non-transitory processor-readable storage medium of claim 24, wherein the stored processor-executable instructions are configured to cause a processor of a computing device to perform operations such that determining whether a value of the identifying factor matches a value of the communication factor comprises:
determining whether a value of a first identifying factor matches a value of a first communication factor;
determining whether a second identifying factor is needed to identify execution of the processor-executable code; and
determining whether a value of the second identifying factor matches a value of a second communication factor in response to determining that the second identifying factor is needed to identify execution of the processor-executable code.

26. The non-transitory processor-readable storage medium of claim 25, wherein the stored processor-executable instructions are configured to cause a processor of a computing device to perform operations further comprising:
determining whether another identifying factor is need to identify execution of the processor-executable code in response to determining that the value of the second identifying factor matches the value of the second communication factor.

27. The non-transitory processor-readable storage medium of claim 25, wherein:
a type of the first identifying factor and the first communication factor is different from a type of the second identifying factor and the second communication factor; and
the stored processor-executable instructions are configured to cause a processor of a computing device to perform operations such that determining whether a second identifying factor is need to identify execution of the processor-executable code comprises determining whether the second identifying factor is need to identify execution of the processor-executable code in response to in response to determining that the value of the first identifying factor matches the value of the first communication factor, the value of the first communication factor not uniquely identifying the processor-executable code, or an overhead for monitoring the first communication factor exceeds a threshold.

28. The non-transitory processor-readable storage medium of claim 24, wherein the stored processor-executable instructions are configured to cause a processor of a computing device to perform operations such that monitoring for a communication factor in a communication between the components and the memory hierarchy of the computing device of a same type as the identifying factor comprises:
determining whether a memory access request to a first target memory of the memory hierarchy results in a miss; and
monitoring a supplemental memory access request to a second target memory of a lower level of the memory hierarchy in response to determining that the memory access request results in a miss.

29. The non-transitory processor-readable storage medium of claim 24, wherein:
the stored processor-executable instructions are configured to cause a processor of a computing device to perform operations such that the communication is associated with a target memory of the memory hierarchy; and
the stored processor-executable instructions are configured to cause a processor of a computing device to perform operations further comprising:
determining whether the communication can be monitored; and
marking the communication un-cacheable in response to determining that the communication cannot be monitored.

30. The non-transitory processor-readable storage medium of claim 24, wherein the stored processor-executable instructions are configured to cause a processor of a computing device to perform operations such that a type of the identifying factor and the communication factor comprises one of an entry point address of a target memory, an exit point address of a target memory, a callee function, a caller function, a parameters, a unique instruction, a unique pattern, a cache footprint, a local variable, and a return value.
